(19) United States
(12) Patent Application Publication
(10) Pub. No.: US 2024/0426743 A1
(43) Pub. Date: Dec. 26, 2024

(54) CUVETTE FOR A PHOTOMETRIC MEASUREMENT OF A SAMPLE, METHOD FOR A PHOTOMETRIC MEASUREMENT OF A SAMPLE, SYSTEM FOR A PHOTOMETRIC ANALYSIS OF A SAMPLE AND METHOD FOR A PHOTOMETRIC ANALYSIS OF A SAMPLE

(71) Applicant: HACH LANGE GMBH, Berlin (DE)

(72) Inventors: Andreas Golitz, Kamp-Lintfort (DE); Michael Kussmann, Düsseldorf (DE)

(21) Appl. No.: 18/292,709

(22) PCT Filed: Jul. 28, 2021
(86) PCT No.: PCT/EP2021/071113

§ 371 Date: Jan. 26, 2024

(51) Int. Cl. G01N 21/03; B01L 3/00; G01N 21/31

(52) U.S. Cl. CPC G01N 21/03; B01L 3/50825; G01N 21/31

(57) ABSTRACT

An aspect of the present invention relates to a cuvette for a photometric measurement of a sample, the cuvette comprising: a sample container; and at least one photometer. Further aspects of the present invention relate to a method for a photometric measurement of a sample, a system for a photometric analysis of a sample and a method for a photometric analysis of a sample.

The present invention relates to a cuvette for a photometric measurement of a sample, a method for a photometric measurement of a sample, a system for a photometric analysis of a sample and a method for a photometric analysis of a sample.

Commonly, a cuvette is a device comprising a sample container for holding a sample to be analyzed and used for photometric measurements and analyses of a sample. For an analysis of a sample, the cuvette is prefilled with reagents suitable for the analysis of such substances as phosphorus, ammonium, and/or any other chemicals suitable for a photometric analysis. The analysis of the sample is normally done by using a separate photometer detecting the absorption and/or reflection spectra of the sample with respect to a reference substance. Such a photometer is expensive, prone to complex repairs and/or has high maintenance costs. A user analyzing, for example, water usually has to carry two devices, the cuvette and the photometer. Therefore, water analysis becomes complex, unpleasant and costly.

Thus, a problem to be solved by the present invention is to provide an improved cuvette and respective method for a photometric measurement of a sample, and an improved system and respective method for a photometric analysis of a sample, particularly allowing for an ease of use.

This problem is solved by the independent claims. Specific embodiments of the present invention are specified in the respective dependent claims.

An aspect of the present invention relates to a cuvette for a photometric measurement of a sample, the cuvette comprising:
a sample container; and
at least one photometer.

Advantageously, the cuvette of the aforesaid aspect is more cost-efficient since it requires no complex repairs and/or maintenance costs and no high investment costs in manufacturing the cuvette. Furthermore, the cuvette can be more compact. Moreover, a user only needs one single device when photometrically measuring and/or analyzing a sample.

In the following, the cuvette is described with respect to a reference cartesian xyz-system aligned with earth. The term “vertical” refers to the z-axis of this reference system. The term “horizontal” refers to the x-axis and/or y-axis of the reference system. In other words, the vertical direction is perpendicular to the earth ground. The horizontal direction is parallel to the earth ground. For the sake of this description, it is assumed that the cuvette is positioned on the earth ground. The terms “lower” and “upper” refer to the vertical direction, i.e., the z-axis of the reference system.

The sample container is a container for holding a sample to be measured. It may have any shape suitable to store or hold the sample. Particularly, the sample container may have a cuboid shape, cylindrical shape, or ball shape. The sample container may have a rectangular or circular cross-section in a horizontal direction. More particularly, the sample container may have a cube shape, wherein the sample container has a square cross-section in a horizontal direction. The sample container may comprise a wall confining an interior of the sample container where the sample can be stored or hold.

A cylindrical sample container may have a diameter between about 5 and about 30 mm. A sample container with a cuboid shape may have a rectangular cross-section, wherein an edge of the rectangular cross-section may have a length of up to about 10 mm and another edge of the rectangular cross-section perpendicular to the aforesaid edge may have a length of up to about 100 mm. The sample container may have an interior volume of about 1 to about 20 ml.

The wall may have an opening. The opening may be closable by, for example, a cover, a plug, a lid, or any other means suitable for closing the opening. The wall of the sample container may be made of any material transparent to a certain wavelength of light used by the photometer. The wall may also not be transparent to visible light.

The wall may be made of any transparent material such as glass, transparent plastics like polystyrene, PMMA, PET, PC, COC or any other suitable transparent material.

With respect to the above-mentioned reference system, the sample container may, in a vertical direction, have an upper end and a lower end. Both the upper end and the lower end may each comprise a horizontal surface. The term “end” may also refer to a portion of the sample container of a thickness from the outer surface of the sample container within a certain range. The range may be 0 to 10 mm. Particularly, the range may be 0 to 5 mm. More particularly, the range may be 0 to 1 mm. Even more particularly, the range may be 0 to 0.5 mm.

Further, the sample container may have, in a horizontal direction, a side surface. The side surface may be perpendicular to the upper end and/or the lower end. The opening may be disposed at the upper end, the lower end, or the side surface. The upper end may be a longitudinal end of the sample container. The lower end may be another longitudinal end of the sample container. The side surface may be a transversal end of the sample container. In the vertical direction, the sample container may have a length greater than the width of the sample container in the horizontal direction.

In the context of this description, the photometer is an instrument that measures the strength of electromagnetic radiation in the range from ultraviolet to infrared and including the visible spectrum. By the photometer, for example, the absorption spectrum and/or reflection spectrum of the sample may be determined. The photometer may comprise a light emitter and a light receiver. The photometer may further comprise a housing in which the light emitter and the light receiver may be disposed. The light emitter of the photometer and the light receiver of the photometer may be spaced apart in such a way that light emitted by the light emitter may be at least partly received by the light receiver. The light emitter of the photometer and the light receiver of the photometer may be arranged at substantially opposing positions on the sample container. The light emitter of the photometer and the light receiver of the photometer may also be arranged adjacently to each other. When arranged adjacently to each other, the light emitter of the photometer may emit light which may be at least partly absorbed by the sample in the sample container and the light receiver of the photometer may at least partly receive light of a wavelength absorbed by the sample and emitted back towards the light receiver. Alternatively or additionally, the light receiver of the photometer may at least partly receive light absorbed and reemitted by the sample, in particular light emitted by luminescence such as fluorescence or phosphorescence, and/or light reflected from the sample. The light receiver may also at least partly receive light transmitted through the sample.

In a specific embodiment, the photometer may be mounted to the sample container.

Advantageously, by mounting the photometer to the sample container, the measurement or analysis of the sample using the cuvette may be facilitated because a user only needs one single device for the photometric measurement or analysis of the sample. The ease of use of the cuvette can be increased. The costs for equipment acquisition can be reduced.

The light emitter of the photometer and the light receiver of the photometer may be directly or indirectly mounted to the sample container. The light receiver may be mounted substantially oppositely to the light emitter. The light emitter and the light receiver may be mounted on substantially opposite sides of the sample container. The light emitter and the light receiver may also be mounted to the sample container adjacently to each other. The light emitter and the light receiver of the photometer may be mounted on substantially the same side of the sample container. When the light emitter and the light receiver are mounted on substantially the same side of the sample container, the photometer may detect light emitted back by the sample after absorption and/or light reflected by the sample.

The photometer may be configured to detect and/or measure transmission and/or reflection spectra of the sample in the sample container.

The photometer may be directly installed or provided on the cuvette. The photometer may be mounted to the wall of the sample container. Specifically, the photometer may be mounted to the wall from the outside of the sample container. It may also be mounted to the wall from the inside or the interior of the sample container. The photometer may be mounted to the sample container by flanging the photometer to the sample container, by screwing the photometer on the sample container, by using an adhesive, and/or by press fitting.

In a specific embodiment, the photometer may be removably mounted to or near a longitudinal end of the sample container.

Advantageously, maintenance of the photometer can be simplified by removably mounting the photometer to the sample container. For instance, the photometer can be demounted for recalibration. Moreover, in case the photometer is broken, it can be repaired more easily and even exchanged more easily.

For example, the photometer can be removably mounted to the longitudinal end of the sample container by using a flange or by using screws. Alternatively, the photometer may be mounted to a transversal end of the sample container in a horizontal direction. For example, the transversal end can be a side surface in horizontal direction of the sample container as described above.

The photometer may also be fixedly mounted to the sample container.

In a specific embodiment, the longitudinal end of the sample container may be a lower end of the sample container.

Advantageously, according to this embodiment, the cuvette can particularly easily be constructed and handled.

Alternatively, the longitudinal end may be the upper end of the sample container. Depending on the orientation of the cuvette with respect to the above-mentioned reference system, the longitudinal end may also be a side surface of the sample container in horizontal direction.

The photometer may be directly integrated on or near a lower part of the sample container.

In a specific embodiment, the sample container may be sealable by the photometer.

Advantageously, the cuvette can be made even more compact since no additional seals are necessary. The photometer may be used as sealing plug or sealing cover of the sample container.

The photometer may also be integrated in the sample container. The photometer may be integrated in the wall of the sample container. It may be integrated in the wall of the sample container when the sample container is produced.

Advantageously, the cuvette can become even more compact and photometric measurements may be facilitated and rendered more convenient for a user of the cuvette.

The light emitter of the photometer and the light receiver of the photometer may be integrated in substantially opposite sides of the sample container.

In a specific embodiment, the photometer may be mounted to the sample container via a label.

Advantageously, the cuvette can become even more compact and manufacturing costs can be reduced.

The light emitter of the photometer and the light receiver of the photometer may be mounted to opposite sides of the sample container via the label.

In the context of this description, the label may be considered as a sheet which may be of any printable or imprintable material. The label can for example be a sheet of paper. It can also be a substrate on which ink suited for 3D-printing may be disposed.

The label may contain information about the cuvette, its use and the reference sample. The label may have the information printed on one side of the label. By an adhesive on another side of the label, the label may be attached to the exterior surface of the wall of the sample container. The label may be continuous or comprised of several discrete pieces.

In a specific embodiment, the photometer may be integrated in the label.

Advantageously, the cuvette can be made even more compact by integrating the photometer in the label.

The photometer may be integrated by being printed on the label and/or being printed together with the label. The photometer may also be printed and afterwards disposed on the label. At least parts of the photometer may be printed. A part of or all of the electronic components of the photometer including a photodiode such as a LED and a power supply or voltage source such as a battery may be printed and disposed on the label. The electronic components may be printed on the label. The label and the electronic components may be printed at the same time.

Advantageously, by printing at least some of the components of the photometer, the cuvette can be made very compact and its production costs can be lowered.

The photometer may also be printed on the exterior surface of the wall of the sample container. It can be printed directly on the exterior surface of the wall of the sample container. Alternatively, the photometer can be integrated in the wall of the sample container. The part of or all of the electronic components of the photometer may be printed directly on the exterior surface of the wall of the sample container.

The photometer may include a printed LED and/or a printed battery and/or an organic photodiode. The printed LED may also be a printed infrared LED.

Organic photodiodes are very thin and flexible. By using an organic photodiode, the cuvette can be made very compact and the flexibility in producing the cuvette may be increased since various shapes of the sample container, in particular of the wall of the sample container, are possible. The organic photodiode is flexible such that it can adapt to the shape of the sample container.

In a specific embodiment, the cuvette may further comprise a lid by which the sample container may be sealable.

Advantageously, the sample can be inserted into the sample container more easily and prevented from leaving the sample container during measurement.

The lid may close the opening in the wall of the sample container.

In a specific embodiment, the cuvette may further comprise at least one power supply. The power supply may be or comprise a battery, in particular a printed battery, one or more photovoltaic cells and/or a wired connection to an external voltage source, wherein the wired connection connects the sample container and the photometer. The sample container may also comprise one or more electronic connections between the wall of the sample container and the photometer, and the wired connection may connect the sample container to the power supply. The power supply may be disposed on or at the sample container. The power supply specifically may be integrated in the wall of the sample container. The wall may also comprise one or more electronic connections connecting the photometer and the power supply.

In a specific embodiment, the cuvette may further comprise a lid by which the sample container may be sealable and a power supply, wherein the power supply specifically may be integrated in the lid.

Advantageously, the cuvette may be made very compact while the sample to be measured can be inserted and removed more easily and the maintenance of the power supply may be facilitated.

In a specific embodiment, the sample container generally has a tube-like shape. The sample container may have a longitudinal direction referring to the length direction of the sample container and a transversal direction referring to the thickness direction of the sample container. The sample container may substantially have a circular or polygonal, in particular rectangular, cross-section in a plane perpendicular to the longitudinal direction of the sample container having a tube-like shape.

In a specific embodiment, the sample may be a solution. The sample may be a gas, fluid, a suspension and/or solid. The solution may, for example, be water or any other substance capable of being measured or analyzed photometrically or by using at least one photometer.

In a specific embodiment, the cuvette may further comprise a transmitting unit for transmitting spectroscopic data of the sample measured or determined by the photometer.

Advantageously, by the transmitting unit, the cuvette can be in communication with another unit, such as a receiving unit (e.g. a computer device or system) as described below. The measured data can be transmitted to this unit and further processed by this unit. In the latter unit, the measured data can be analyzed and/or output to a user. The transmitting unit can also transmit information and/or data about the battery status of the photometer and/or error messages and/or maintenance information.

The spectroscopic data may include the absorption spectrum of the sample and/or the reflection spectrum of the sample and/or light intensities of light transmitted through the sample or reflected from the sample and/or the light extinction. Specifically, the measurement of the photometer(s) may be indicative of an illuminance, an irradiance, a light absorption, a scattering of light, a reflection of light, fluorescence, a phosphore-scence and/or a luminescence of the measured sample.

The transmitting unit may comprise or be a Bluetooth interface, the Bluetooth interface delivering the spectroscopic data directly to another unit such as a receiving unit, as described below, being in communication with the transmitting unit. Alternatively, the transmitting unit may comprise or be a WLAN or NFC interface for wireless communication. The transmitting unit may comprise an antenna for wireless communication and/or a connector for a wired connection.

The transmitting unit may be mounted to the sample container. The transmitting unit may be mounted to the sample container by using screws and/or an adhesive. The transmitting unit may be disposed on the exterior surface of the wall of the sample container. Alternatively or additionally, the transmitting unit may be mounted to the sample container via the label. The transmitting unit may be printed on or integrated in the wall of the sample container. The transmitting unit may also be integrated in the label. It may be integrated in the label by printing the label and the transmitting unit at the same time or it may be printed on the label. The transmitting unit may be directly printed on the exterior surface of the wall of the sample container.

The photometer may also have an interface for outputting the measured spectroscopic data. This interface may, for example, be a display for prompting the data to a user and/or an antenna for wireless communication and/or a connector for a wired connection. The photometer may also be configured to analyze the measured data. The photometer may comprise the transmitting unit.

Another aspect of the present invention relates to a method for a photometric measurement of a sample, the method comprising the following steps:
providing a cuvette comprising:
   a sample container; and
   at least one photometer;
inserting the sample into the sample container; and
by means of the photometer, measuring the spectroscopic data of the sample.

Advantageously, this method can make photometric measurements of a sample easier, more convenient and less costly.

All aspects, features, specific embodiments and advantages described above with respect to a cuvette for a photometric measurement of a sample can be applied to the aforesaid aspect of a method for a photometric measurement of a sample.

In an embodiment, the method may be performed as follows:

In a first step, a cuvette according to the above-mentioned aspect or one of the specific embodiments may be provided.

In a second step, the sample to be measured may be inserted into the sample container of the cuvette. For example, the sample may be inserted by opening a lid arranged at the sample container.

In a third step, the spectroscopic data of the sample may be measured by the photometer. Afterwards, the photometer may output the measured data by an interface. This interface may be a display and/or an antenna and/or a connector for a wired connection. The photometer may also analyze the measured data before outputting the data. The photometer may calculate for example the extinction of light and/or concentration of a predefined substance in the sample, the substance being predefined by a reference sample. The substance may for example comprise or be a phosphate.

For a photometric measurement of a sample according to the above-described method, the cuvette may be prefilled with chemicals and/or reagents including for example ammonium vanadate, ammonium molybdate and sulfuric acid (for the analysis of phosphorous ions).

The above-described method may be performed by a system according to the aspect below. The method may be automized and/or performed automatically by the system.

Yet another aspect of the present invention relates to a system for a photometric analysis of a sample, the system comprising:
the cuvette according to an embodiment as described above in which the cuvette further comprises a transmitting unit for transmitting spectroscopic data of the sample measured by the photometer; and
a receiving unit for receiving the spectroscopic data transmitted by the transmitting unit;
wherein the transmitting unit and the receiving unit are in communication with each other; and
wherein the receiving unit has at least one processor for processing the spectroscopic data received by the receiving unit and an interface to output the spectroscopic data received by the receiving unit.

Advantageously, by using the above-mentioned system, the photometric analysis of a sample may be made more efficient.

All aspects, features, specific embodiments and advantages described above with respect to a cuvette for a photometric measurement of a sample can be applied to the aforesaid aspect of a system for a photometric analysis of a sample.

The receiving unit may comprise an antenna for a wireless connection to the transmitting unit and/or a connector for a wired connection to the transmitting unit.

In a specific embodiment, the communication between the transmitting unit and the receiving unit is wireless. The communication may also be wired. The transmitting unit and the receiving unit may be configured to exchange data, such as the spectroscopic data of the sample measured by the photometer and/or data comprising information about the status of the photometer. The latter data may include the battery status of the photometer and/or the repair and maintenance status of components of the photometer.

In a specific embodiment, the receiving unit may be a computing device, wherein the interface of the receiving unit is a display of the computing device for displaying the spectroscopic data. The interface of the receiving unit may also be an antenna and/or a connector for a wired connection to output the spectroscopic data.

In a specific embodiment, the computing device may be a smartphone. The smartphone may comprise a Bluetooth communication unit. The spectroscopic data may be stored in the smartphone or in a cloud storage. The smartphone may be configured to run an application for analyzing and/or editing the measured spectroscopic data.

Yet another aspect of the present invention relates to a method for a photometric analysis of a sample, the method comprising the following steps:
providing a system comprising:
   a cuvette comprising:
      a sample container;
      at least one photometer; and
      a transmitting unit for transmitting spectroscopic data of the sample measured by the photometer; and
   a receiving unit for receiving the spectroscopic data transmitted by the transmitting unit;
   wherein the transmitting unit and the receiving unit are in communication with each other; and
   wherein the receiving unit has at least one processor for processing the spectroscopic data received by the receiving unit and an interface to output the spectroscopic data received by the receiving unit;
inserting the sample into the sample container;
by means of the photometer, measuring the spectroscopic data of the sample;
by means of the transmitting unit, transmitting the spectroscopic data to the receiving unit; and
by means of the interface of the receiving unit, outputting the spectroscopic data received by the receiving unit.

Advantageously, this method can make photometric analyses of a sample easier, more convenient and less costly.

All aspects, features, specific embodiments and advantages described above with respect to a system for a photometric analysis of a sample can be applied to the aforesaid aspect of a method for a photometric analysis of a sample.

In an embodiment, the method may be performed as follows:

In a first step, the cuvette according to an embodiment comprising the transmitting unit may be provided. Further, a communication between the transmitting unit of the cuvette and the receiving unit of the system may be established. A cable for connecting the transmitting unit and the receiving unit may be plugged into the transmitting unit and/or the receiving unit. Alternatively, the transmitting unit and the receiving unit may be paired.

In a second step, the sample may be inserted into the sample container of the cuvette.

In a third step, the spectroscopic data of the sample are measured by the photometer.

In a fourth step, these measured spectroscopic data may be transmitted, by the transmitting unit of the cuvette, to the receiving unit, for example via a wireless connection such as a Bluetooth connection.

In a fifth step, the transmitted spectroscopic data may be output by the interface of the receiving unit. The transmitted spectroscopic data may additionally be processed and analyzed by the receiving unit.

In a specific embodiment, before outputting the spectroscopic data, the at least one processor of the receiving unit may perform spectroscopic analysis calculations on the spectroscopic data received by the receiving unit. Such calculations may comprise calculating the extinction. The calculations may further comprise determining the absorption spectra and/or reflection spectra of the sample and/or determining the concentration of a substance in the sample and/or determining the substance.

The substance may comprise or be a phosphate. The substance may also be or comprise COD, Ammonium, Phosphate, Nitrate, Nitrite, Surfactants, Boron, Potassium, manganese, nickel, tin or any other substance which is suitable to be analyzed by wet chemical methods or may have a specific, recognizable absorption peak or spectrum.

Below, a brief description of the drawings follows. It is to be understood that the drawings are meant to depict aspects, additional features and embodiments of the present invention. Individual features depicted in the drawings may be combined for further embodiments of the present invention.

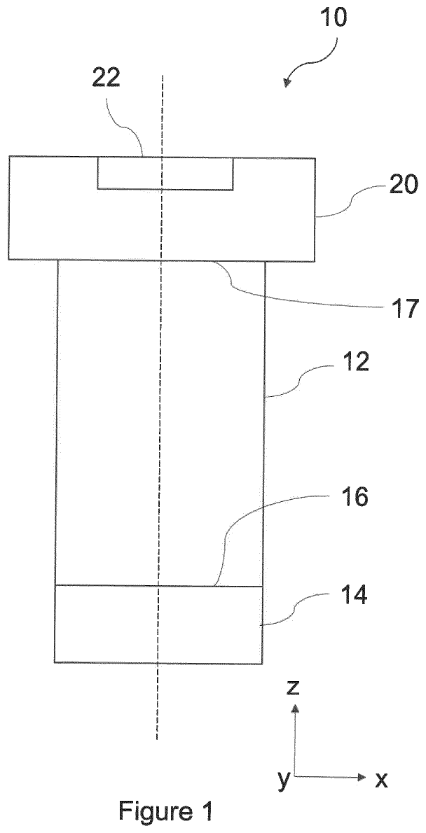

FIG. 1 shows a longitudinal cross-section of a particular embodiment of a cuvette according to the present invention.

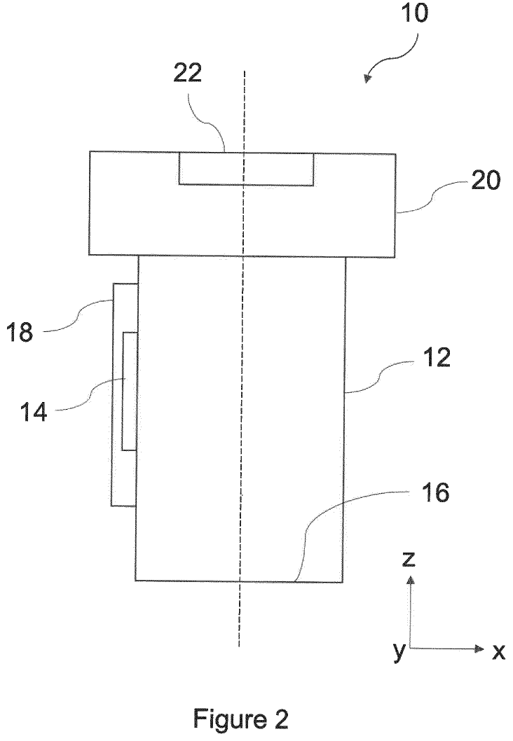

FIG. 2 shows a longitudinal cross-section of another particular embodiment of a cuvette according to the present invention.

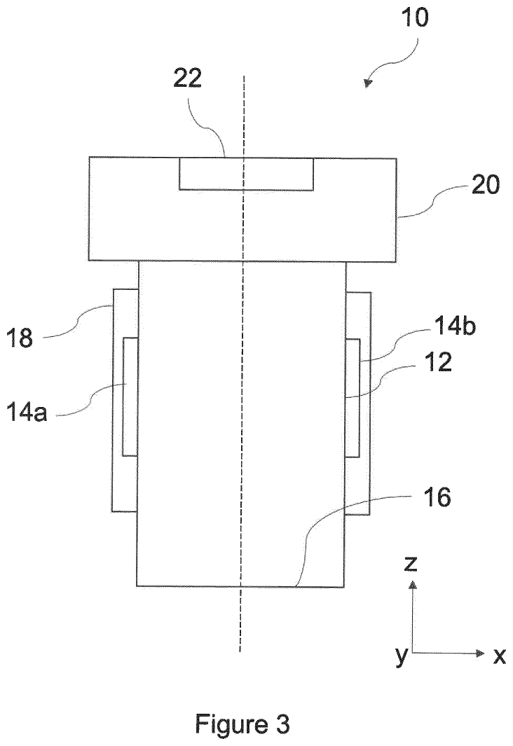

FIG. 3 shows a longitudinal cross-section of another particular embodiment of a cuvette according to the present invention.

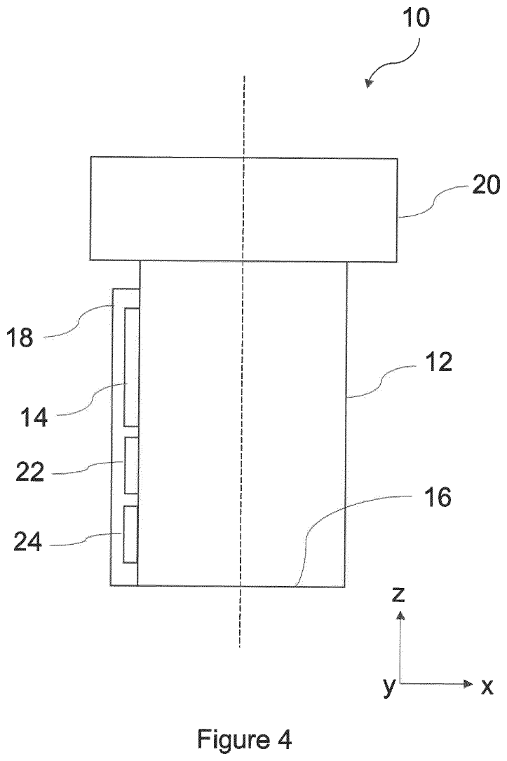

FIG. 4 shows a longitudinal cross-section of another particular embodiment of a cuvette according to the present invention.

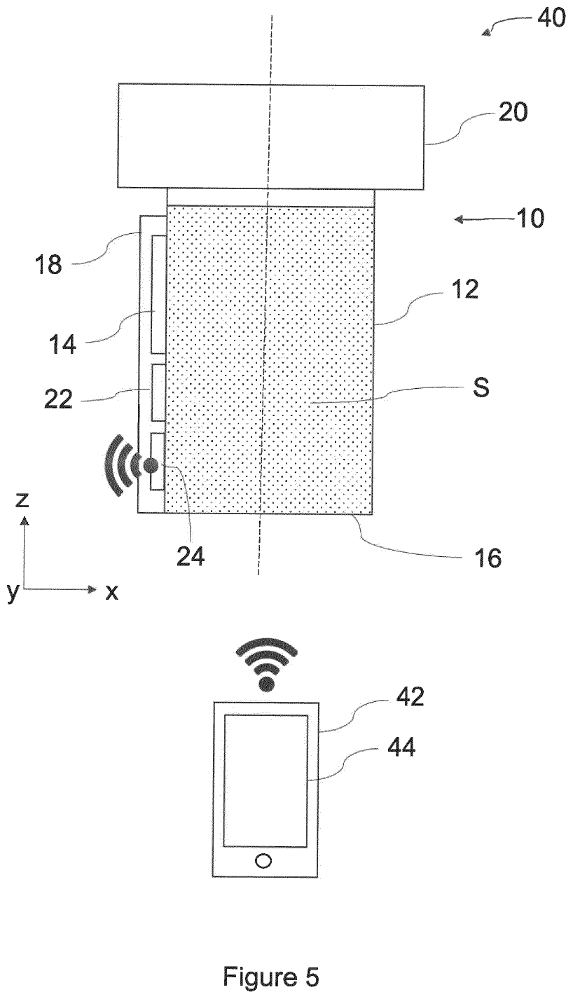

FIG. 5 shows a longitudinal cross-section of a particular embodiment of a system according to the present invention.

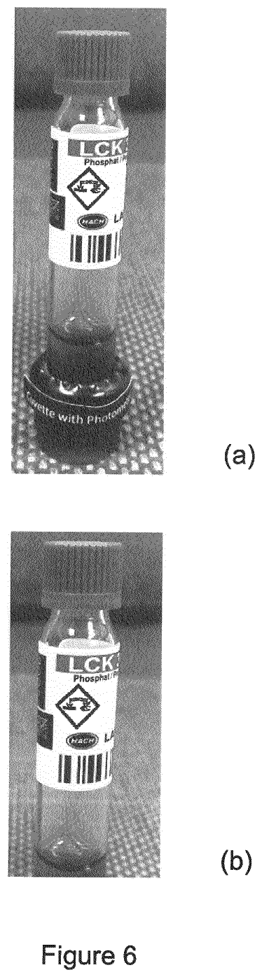

FIG. 6 shows photographic pictures of two particular embodiments of a cuvette according to the present invention in grayscale.

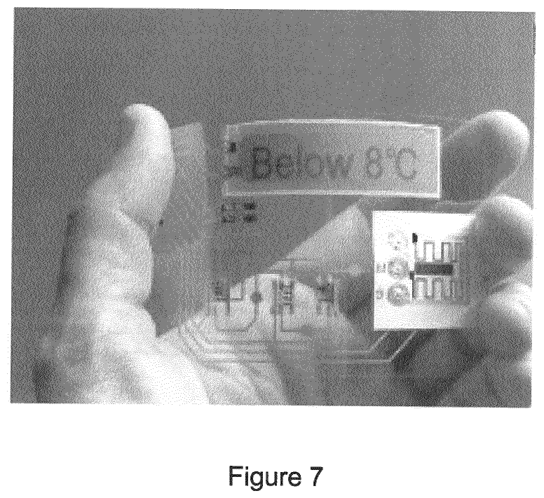

FIG. 7 shows a photographic picture of a label for a cuvette according to the present invention in grayscale.

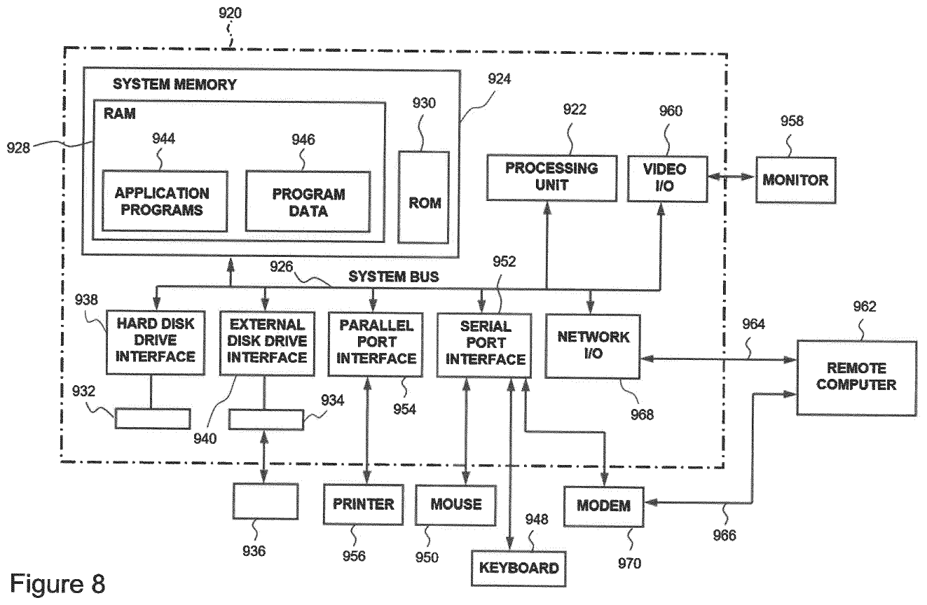

FIG. 8 shows an exemplary system for implementing the invention including a general purpose computing device.

Next, the drawings are described in more detail.

FIG. 1 shows schematically a cuvette 10 according to an embodiment of the present invention. FIG. 1 shows a cross-section of the cuvette 10 along the dashed line, i.e., along the longitudinal axis of the cuvette 10. The longitudinal axis substantially is aligned in use with the z-axis of a reference cartesian xyz-system, the z-axis indicating the vertical direction and the x-axis and/or y-axis indicating the horizontal direction.

The sample container 12 of the cuvette 10 particularly has a substantially cylindrical shape. The sample container 12 may be made of a material at least partly transparent to visible light. The sample container 12 has two longitudinal ends 16 and 17. A longitudinal end 16 is in use the lower or bottom end of the sample container 12. A longitudinal end 17 is in use the upper or top end of the sample container 12. The sample container 12 has an opening which is disposed at or near the upper or top end 17 of the sample container 12 to introduce a sample into the interior of the sample container 12.

The opening of the sample container 12 is or can be closed or sealed by a lid 20. As depicted in FIG. 1, the lid 20 particularly has a substantially cylindrical shape. The lid 20 may be affixed (particularly screwed or snapped) on to the top end of the sample container 12. The lid 20 may also be plugged upon the sample container 12. The lid 20 can seal the sample container 12 off. The lid 20 covers said opening disposed in or at the upper or top end 17 of the sample container 12. Furthermore, the sample container 12 may have another opening which may be disposed at or near the lower or bottom end 16 of the sample container 12 particularly substantially opposed to the opening disposed at the upper end 17.

At least one photometer 14 is arranged at the sample container 12, particularly at or near the lower or bottom end 16 of the sample container 12. The photometer 14 is configured to measure a strength of electromagnetic radiation specifically in the range from ultraviolet to infrared and including the visible spectrum or at least a part of such spectrum. Specifically, the photometer 14 converts light into an electric current using a photoresistor, photodiode, and/or photomultiplier. The photometer 14 is particularly configured to measure one or more of the following parameters: Illuminance, irradiance, light absorption, scattering of light, reflection of light, fluorescence, phosphorescence and/or luminescence. The photometer 14 may be mounted or affixed to the lower end 16 particularly by way of a flange (not shown). The photometer 14 may also be screwed on the lower end 16 of the sample container 12.

The lid 20 and/or the wall of the sample container 12 comprises at least one power supply 22 or voltage source (such as a button cell battery) supplying the photometer 14 with power. An electrical connection (particularly plural wires, not shown) connecting the power supply 22 and the photometer 14 may be integrated into the lid 20 and/or the wall of the sample container 12.

FIG. 2 shows a schematic depiction of a cuvette 10 according to another embodiment of the present invention, which is similar to the cuvette shown in FIG. 1. In FIG. 2, the cuvette 10 further comprises at least one label or tag 18 which is disposed at or on the wall of the sample container 12. The label or tag 18 may be attached or mounted to the sample container 12 by an adhesive. In the present embodiment, the photometer 14 is not disposed at the lower end 16 of the sample container 12 as shown in FIG. 1, but rather the photometer 14 is integrated in the label or tag 18.

The cuvette 10 of FIG. 2 comprises a lid 20 particularly in which a power supply 22 is integrated and electrically connected to the photometer 14 in the label or tag 18 arranged at a side surface of the sample container 12. The photometer 14 and the power supply 22 may be connected by an electrical connection (comprising on or more wires, not shown) which may be disposed in or on the lid 20 and/or the wall of the sample container 12. The photometer 14 may be printed in a 3D-printing process.

FIG. 3 shows a schematic depiction of a cuvette 10 according to another embodiment of the present invention, which is similar to the cuvette shown in FIG. 2. In FIG. 3, the photometer 14 of the cuvette 10 comprises a light emitter 14a and a light receiver 14b. The light emitter 14a of the photometer 14 and the light receiver of the photometer 14b of the photometer 14 are both integrated in the label 18 and arranged at opposing positions on the outer surface of the sample container 12. The label 18 may be wrapped around the sample container 12. The label 18 may be continuous or comprised of several discrete pieces or elements. In FIG. 3, the light emitter 14a and the light receiver 14b are arranged such that light emitted by the light emitter 14a can be detected or received at least partly by the light receiver 14b.

In FIG. 4, a schematic depiction of a cuvette 10 according to another embodiment of the present invention is shown. The cuvette 10 shown in FIG. 4 is similar to the cuvettes shown in FIGS. 1 to 3. In the cuvette 10 of FIG. 4, the photometer 14 and the power supply 22 are integrated in the label or tag 18. The power supply 22 may be or comprise a printed battery and/or photovoltaic cell(s).

Furthermore, the cuvette 10 specifically comprises a transmitting unit 24, which particularly may also be integrated in the label or tag 18 as shown in FIG. 4. The transmitting unit 24 may comprise or be an antenna and may be suitable for wireless communication particularly according to a short-range wireless technology standard such as Bluetooth, NFC and/or WLAN. The transmitting unit 24 may be printed as well. The transmitting unit 24 may also comprise or be a connector for a wired connection to a receiving unit as shown in FIG. 5 as described herein below.

FIG. 5 shows a schematic depiction of a system 40 according to an embodiment of the present invention. The system 40 comprises the cuvette 10 as depicted in FIG. 4. FIG. 5 further shows the measurement and analysis of a sample S by means of the system 40.

A sample S (dotted area in the sample container 12) has been inserted or introduced into the sample container 12 via the opening at the longitudinal end 17 particularly after having removed the lid 20. The photometer 14 is activated (e.g. upon or after inserting the sample S into the sample container 12 of the cuvette 10) by a sample detection sensor and/or by a user input such as pressing a button or applying a touch gesture on the photometer 14. The photometer 14 may also be activated upon user input on a computer device 42 such as mobile device (e.g. a smartphone or tablet) being in wireless communication with the cuvette 10 and running a respective application for controlling the photometer 14. In the application, the battery status of the power supply 22 and the maintenance status of the photometer 14 may also be monitored.

Upon activation of the photometer 14, the photometer 14 performs a photometric or spectroscopic measurement of the sample S. The measurement of the photometer 14 is indicative of the illuminance, the irradiance, the light absorption, the scattering of light, the reflection of light, the fluorescence, the phosphorescence and/or the luminescence of the sample S arranged in the sample container 12.

The measured data (or information indicative thereof) are forwarded to the transmitting unit 24 and transmitted, by the transmitting unit 24 (e.g. via a Bluetooth or WLAN connection or NFC) to the smartphone or tablet 42.

On the computer device 42, particularly on the mobile device (smartphone or tablet) 42, the data measured by the photometer 14 (or the transmitted information indicative thereof) can be further analyzed by using the respective application run on the computer device 42, and the raw data measured by the photometer 14 and/or the analyzed data can be outputted particularly via a graphical user interface (such as a display 44) of the computer device 42. Additionally, the measured data and/or measured and analyzed data can be stored in the storage of the computer device 42 for future uses. The application run on the computer device (e.g. the smartphone or tablet) 42 may also provide a connection to a cloud storage where said data can be remotely stored.

The cuvette 10 and the computer device 42 are in communication with each other via the transmitting unit 24 of the cuvette 10, and data between the transmitting unit 24 and the computer device 42 can be exchanged.

FIGS. 6(a) and 6(b) show photographic grayscale pictures of two cuvettes according to embodiments of the invention. FIG. 6(a) shows a picture of a cylindrical cuvette, wherein at least one photometer is firmly flanged to a lower longitudinal end or bottom end of the cuvette. FIG. 6(b) shows a picture of a cylindrical cuvette, wherein a photometer is integrated into the label of the cuvette by using very thin and flexible electronic components for the photometer such as printed LEDs and/or organic photodiodes and/or a printed battery.

FIG. 7 shows a photographic grayscale picture of a label for a cuvette. The label shown contains the electronic components of the photometer of the cuvette. The shown label is a transparent film containing one or more printed electronics.

FIG. 8 shows an exemplary system for implementing the invention including a general purpose computing device in the form of a conventional computing environment 920 (e.g. a personal computer) which may be used as the computer device 42 described in connection with the above embodiments.

The conventional computing environment includes a processing unit 922, a system memory 924, and a system bus 926. The system bus couples various system components including the system memory 924 to the processing unit 922. The processing unit 922 may perform arithmetic, logic and/or control operations by accessing the system memory 924. The system memory 924 may store information and/or instructions for use in combination with the processing unit 922.

The system memory 924 may include volatile and non-volatile memory, such as a random access memory (RAM) 928 and a read only memory (ROM) 930. A basic input/output system (BIOS) containing the basic routines that helps to transfer information between elements within the personal computer 920, such as during start-up, may be stored in the ROM 930. The system bus 926 may be any of several types of bus structures including a memory bus or memory controller, a peripheral bus, and a local bus using any of a variety of bus architectures.

The personal computer 920 may further include a hard disk drive 932 for reading from and writing to a hard disk (not shown), and an external disk drive 934 for reading from or writing to a removable disk 936. The removable disk may be a magnetic disk for a magnetic disk driver or an optical disk such as a CD ROM for an optical disk drive. The hard disk drive 932 and the external disk drive 934 are connected to the system bus 926 by a hard disk drive interface 938 and an external disk drive interface 940, respectively. The drives and their associated computer-readable media provide nonvolatile storage of computer readable instructions, data structures, program modules and other data for the personal computer 920. The data structures may include relevant data for the implementation of the method for a photometric measurement of a sample S and/or the method for a photometric analysis of a sample S, as described above. The relevant data may be organized in a database, for example a relational database management system or an object-oriented database management system.

Although the exemplary environment described herein employs a hard disk (not shown) and an external disk 936, it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk, external disk 936, ROM 930 or RAM 928, including an operating system (not shown), one or more application programs 944, other program modules (not shown), and program data 946.

A user may enter commands and information, as discussed below, into the personal computer 920 through input devices such as keyboard 948 and mouse 950. Other input devices (not shown) may include a microphone (or other sensors), joystick, game pad, scanner, or the like. These and other input devices may be connected to the processing unit 922 through a serial port interface 952 that is coupled to the system bus 926, or may be collected by other interfaces, such as a parallel port interface 954, game port or a universal serial bus (USB). Further, information may be printed using printer 956. The printer 956, and other parallel input/output devices may be connected to the processing unit 922 through parallel port interface 954. A monitor 958 or other type of display device is also connected to the system bus 926 via an interface, such as a video input/output 960. In addition to the monitor, computing environment 920 may include other peripheral output devices (not shown), such as speakers or other audible output.

The computing environment 920 may communicate with other electronic devices such as a computer, telephone (wired or wireless), personal digital assistant, television, or the like. To communicate, the computer environment 920 may operate in a networked environment using connections to one or more electronic devices. FIG. 8 depicts the computer environment networked with remote computer 962. The remote computer 962 may be another computing environment such as a server, a router, a network PC, a peer device or other common network node, and may include many or all of the elements described above relative to the computing environment 920. The logical connections depicted in FIG. 8 include a local area network (LAN) 964 and a wide area network (WAN) 966. Such networking environments are commonplace in offices, enterprise-wide computer networks, intranets and the Internet and may particularly be encrypted.

When used in a LAN networking environment, the computing environment 920 may be connected to the LAN 964 through a network I/O 968. When used in a WAN networking environment, the computing environment 920 may include a modem 970 or other means for establishing communications over the WAN 966. The modem 970, which may be internal or external to computing environment 920, is connected to the system bus 926 via the serial port interface 952. In a networked environment, program modules depicted relative to the computing environment 920, or portions thereof, may be stored in a remote memory storage device resident on or accessible to remote computer 962. Furthermore, other data relevant to the method for a photometric measurement of a sample S and/or the method for a photometric analysis of a sample S (described above) may be resident on or accessible via the remote computer 962. It will be appreciated that the network connections shown are exemplary and other means of establishing a communications link between the electronic devices may be used.

The above-described computing system is only one example of the type of computing system that may be used to implement the method for a photometric measurement of a sample S and/or the method for a photometric analysis of a sample S.

In conclusion, according to the present disclosure a more cost-efficient cuvette 10 is provided, since it requires no complex repairs and/or maintenance costs and no high investment costs in manufacturing the cuvette 10. Furthermore, the cuvette 10 can be more compact. Moreover, a user only needs one single device when photometrically measuring and/or analyzing a sample. Further there is provided a respective method for a photometric measurement of a sample, the method allowing photometric measurements of a sample to be easier, more convenient and less costly.

Furthermore, there is provided a system for a photometric analysis of a sample, which allows for a more efficient photometric analysis of a sample. The present disclosure also relates to a respective method for a photometric analysis of a sample which renders the photometric analysis of a sample easier, more convenient and less costly.

### LIST OF REFERENCE NUMERALS

10 cuvette
12 sample container
14 photometer
14a light emitter of the photometer
14b light receiver of the photometer
16, 17 longitudinal end of the sample container
18 label
20 lid
22 power supply
24 transmitting unit
40 system
42 receiving unit
44 interface
920 conventional computing environment
922 processing unit
924 system memory
926 system bus
928 random access memory (RAM)
930 read only memory (ROM)
932 hard disk drive
934 external disk drive
936 removable disk
938 hard disk drive interface
940 external disk drive interface
944 one or more application programs
946 program data
948 keyboard
950 mouse
952 serial port interface
954 parallel port interface
956 printer
958 monitor
960 video input/output
962 remote computer
964 local area network (LAN)
966 wide area network (WAN)
968 network I/O
970 modem
S sample

1-20. (canceled)

21. A cuvette for a photometric measurement of a sample, the cuvette comprising:
a sample container; and
at least one photometer.

22. The cuvette according to claim 21, wherein the photometer is mounted to the sample container.

23. The cuvette according to claim 22, wherein the photometer is removably mounted to a longitudinal end of the sample container.

24. The cuvette according to claim 23, wherein the longitudinal end of the sample container is a lower end of the sample container.

25. The cuvette according to claim 21, wherein the sample container is sealable by the photometer.

26. The cuvette according to claim 21, wherein the photometer is mounted to the sample container via a label.

27. The cuvette according to claim 26, wherein the photometer is integrated in the label.

28. The cuvette according to claim 21, wherein the cuvette further comprises a lid by which the sample container is sealable.

29. The cuvette according to claim 21, wherein the cuvette further comprises a power supply.

30. The cuvette according to claim 21, wherein the cuvette further comprises a lid by which the sample container is sealable and a power supply, wherein the power supply is integrated in the lid.

31. The cuvette according to claim 21, wherein the sample container has a tube-like shape.

32. The cuvette according to claim 21, wherein the sample is a solution.

33. The cuvette according to claim 21, wherein the cuvette further comprises a transmitting unit for transmitting spectroscopic data of the sample measured by the photometer.

34. A system for a photometric analysis of a sample, the system comprising:
a cuvette, wherein the cuvette further comprises a transmitting unit for transmitting spectroscopic data of the sample measured by a photometer; and
a receiving unit for receiving the spectroscopic data transmitted by the transmitting unit;
wherein the transmitting unit and the receiving unit are in communication with each other; and
wherein the receiving unit has at least one processor for processing the spectroscopic data received by the receiving unit and an interface to output the spectroscopic data received by the receiving unit.

35. The system according to claim 34, wherein the communication is wireless.

36. The system according to claim 34, wherein the receiving unit is a computing device, wherein the interface is a display of the computing device for displaying the spectroscopic data.

37. The system according to claim 36, wherein the computing device is a smartphone.

38. A method for a photometric measurement of a sample, the method comprising the following steps:
providing a cuvette comprising:
a sample container; and
at least one photometer;
inserting the sample into the sample container; and
measuring the spectroscopic, using the photometer, data of the sample.

39. A method for a photometric analysis of a sample, the method comprising the following steps:
providing a system comprising:
a cuvette comprising:
a sample container;
at least one photometer; and
a transmitting unit for transmitting spectroscopic data of the sample measured by the photometer; and
a receiving unit for receiving the spectroscopic data transmitted by the transmitting unit;
wherein the transmitting unit and the receiving unit are in communication with each other; and
wherein the receiving unit has at least one processor for processing the spectroscopic data received by the receiving unit and an interface to output the spectroscopic data received by the receiving unit;
inserting the sample into the sample container;
measuring the spectroscopic data, using the photometer, of the sample;
transmitting the spectroscopic data, using the transmitting unit, to the receiving unit; and
outputting the spectroscopic data, using the interface of the receiving unit, received by the receiving unit.

40. The method according to claim 39, wherein, before outputting the spectroscopic data, the at least one processor performs spectroscopic analysis calculations on the spectroscopic data received by the receiving unit.
